(19) United States
(12) Patent Application Publication
(10) Pub. No.: US 2025/0238368 A1
(43) Pub. Date: Jul. 24, 2025

(54) TECHNIQUES FOR INITIATING CHECKPOINT OPERATIONS IN A MEMORY SYSTEM

(71) Applicant: Micron Technology, Inc., Boise, ID (US)

(72) Inventor: Wenjun Wu, Shanghai (CN)

(21) Appl. No.: 19/020,949

(22) Filed: Jan. 14, 2025

Related U.S. Application Data
(60) Provisional application No. 63/624,159, filed on Jan. 23, 2024.

(51) Int. Cl. G06F 12/06

(52) U.S. Cl. CPC G06F 12/06; G06F 2212/657

(57) ABSTRACT

Methods, systems, and devices for techniques for initiating checkpoint operations in a memory system are described. A memory system may be configured to initiate a checkpoint operation prior to the change log reaching capacity, for example, by initiating the checkpoint procedure based on whether a quantity of metadata tables to be updated during the checkpoint operation satisfies a threshold. For example, the memory system may update logical-to-physical (L2P) address mappings in volatile memory of the memory system, where each L2P address mapping may correspond to a respective metadata table. The memory system may determine whether to update the respective metadata tables based on a quantity of metadata tables associated with the updated L2P address mappings satisfying a first threshold or based on a quantity of updated L2P address mappings satisfying a second threshold. If either the first or second thresholds are satisfied, the memory system may initiate the checkpoint procedure.

### CROSS REFERENCE

The present Application for Patent claims priority to U.S. Patent Application No. 63/624,159 by Wu, entitled “TECHNIQUES FOR INITIATING CHECKPOINT OPERATIONS IN A MEMORY SYSTEM,” filed Jan. 23, 2024, which is assigned to the assignee hereof, and which is expressly incorporated by reference in its entirety herein.

### TECHNICAL FIELD

The following relates to one or more systems for memory, including techniques for initiating checkpoint operations in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for initiating checkpoint operations in a memory system in accordance with examples as disclosed herein.

FIG. 2 shows an example of a metadata architecture that supports techniques for initiating checkpoint operations in a memory system in accordance with examples as disclosed herein.

FIG. 3 shows an example of a process that supports techniques for initiating checkpoint operations in a memory system in accordance with examples as disclosed herein.

FIG. 4 shows a block diagram of a memory system that supports techniques for initiating checkpoint operations in a memory system in accordance with examples as disclosed herein.

FIG. 5 shows a flowchart illustrating a method or methods that support techniques for initiating checkpoint operations in a memory system in accordance with examples as disclosed herein.

### DETAILED DESCRIPTION

A memory system may maintain, for example in volatile memory of the memory system, a change log of updates to metadata, such as logical-to-physical (L2P) address mappings, that occur during operation of the memory system. For example, the memory system may store L2P address mappings based on or in response to one or more access operations (e.g., write operations commanded by a host, memory management operations internal to the memory system), and each of the L2P address mappings may be associated with a respective metadata table (e.g., an L2P table) in non-volatile memory of the memory system. In some examples, if a quantity of the entries in the change log (e.g., a quantity of L2P address mappings) satisfies a threshold quantity of entries (e.g., the change log reaches its capacity), the memory system may perform a checkpoint operation in order to write the L2P address mappings from the change log to respective metadata tables that are stored in non-volatile memory. In such cases, during the checkpoint operation, the memory system may refrain from servicing requests from a host system. However, if the L2P address mappings are associated with a relatively large quantity of metadata tables (e.g., updates to thousands of L2P tables), the memory system may perform the checkpoint operation for a relatively long duration due to loading the relatively large quantity of metadata tables from non-volatile memory to the volatile memory. During such operations, the memory system may not be able to service commands from the host system in a timely manner, thereby increasing latency, among other challenges.

As disclosed herein, a memory system may be configured to initiate (e.g., trigger, begin) a checkpoint operation prior to the change log reaching capacity, for example, by initiating the checkpoint operation based on whether a quantity of metadata tables to be updated during the checkpoint operation satisfies a threshold, which may reduce the duration of the checkpoint operation. For example, the memory system may update (e.g., store) multiple L2P address mappings in volatile memory of the memory system (e.g., in a change log), where each L2P address mapping may correspond to a respective metadata table. The memory system may determine whether to update the respective metadata tables (e.g., perform the checkpoint operation) based on a quantity of metadata tables of the L2P address mappings satisfying a first threshold (e.g., a table-specific threshold) or based on a quantity of updated L2P address mappings (e.g., entries in the change log) satisfying a second threshold (e.g., a threshold quantity of entries of the change log, a change log capacity). By initiating the checkpoint operation based on a threshold quantity of L2P tables, the memory system may reduce the quantity of L2P tables that are to be updated (e.g., performing the checkpoint operation before reaching the threshold quantity of updates or change log capacity), resulting in reduced latency associated with the checkpoint operation, among other advantages.

In addition to applicability in memory systems as described herein, techniques for initiating checkpoint operations in a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by increasing the efficiency and duration of checkpoint procedures, which may decrease latency associated with performing access commands (e.g., write commands, among other benefits.

Features of the disclosure are illustrated and described in the context of systems, devices, and circuits. Features of the disclosure are further illustrated and described in the context of metadata architectures, process flows, and flowcharts.

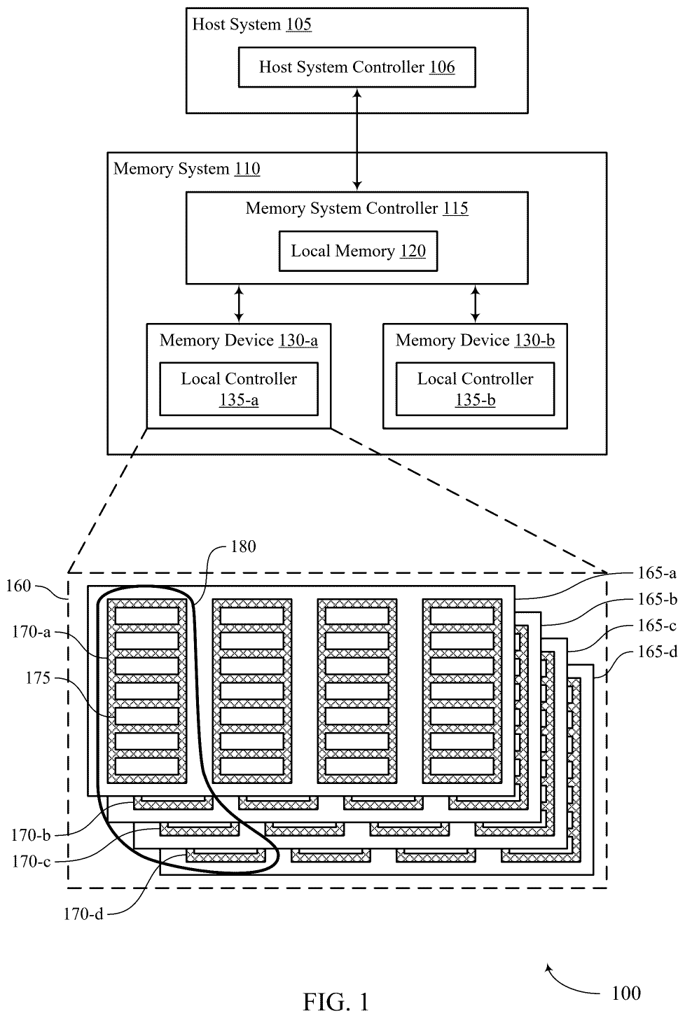

FIG. 1 shows an example of a system 100 that supports techniques for initiating checkpoint operations in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the memory system 110 may maintain (e.g., in a local memory 120, in volatile memory) a change log of updates to metadata, such as L2P address mappings, that occur during operation of the memory system 110. For example, the memory system 110 may store updated L2P address mappings in the change log (e.g., a portion of the local memory 120) in response to one or more access operations (e.g., write operations commanded by the host system 105, memory management operations internal to the memory system 110, memory management operations initiated by a memory system controller 115), and each of the updated L2P address mappings may be associated with a respective metadata table (e.g., an L2P table) stored in non-volatile memory of the memory system 110 (e.g., of one or more memory devices 130, of or coupled with a memory system controller 115). In some examples, if a quantity of updated entries in the change log (e.g., a quantity of updated L2P address mappings) satisfies a threshold quantity of entries (e.g., the change log reaches its capacity), the memory system 110 may perform a checkpoint operation in order to write the updates from the change log to respective metadata tables that are stored in the non-volatile memory (e.g., one or more of the memory devices 130). In such cases, during the checkpoint operation, the memory system 110 may refrain from servicing requests from the host system 105. However, if the updates are associated with a relatively large quantity of metadata tables (e.g., updates to thousands of L2P tables), the memory system 110, via the memory system controller 115, may perform the checkpoint operation for a relatively long duration time due to loading the relatively large quantity of metadata tables from non-volatile memory to the volatile memory (e.g., from one or more memory devices 130 to the local memory 120). During such operations, the memory system 110 may not be able to service commands from the host system 105 in a timely manner, thereby increasing latency.

As disclosed herein, the memory system 110 may be configured to trigger a checkpoint operation based on whether a quantity of metadata tables to be updated during the checkpoint operation satisfies a threshold, which may reduce the duration of the checkpoint operation. For example, a memory system controller 115 may be configured to update the multiple L2P address mappings in the local memory 120 (e.g., in a change log), where each L2P address mapping may correspond to a respective metadata table stored in the non-volatile memory of one or more of the memory devices 130. The memory system controller 115 may determine whether to update the respective metadata tables (e.g., perform the checkpoint operation) based on a quantity of metadata tables associated with the updated L2P address mappings satisfying a first threshold (e.g., a table-specific threshold) or based on a quantity of updated L2P address mappings (e.g., entries in the change log) satisfying a second threshold (e.g., a threshold quantity of entries of the change log). By triggering the checkpoint operation based on a threshold quantity of L2P tables, the memory system controller 115 may reduce the quantity of L2P tables that are to be updated (e.g., performing the checkpoint operation before reaching the threshold quantity of updates or change log capacity), resulting in reduced latency associated with the checkpoint operation.

The system 100 may include any quantity of non-transitory computer readable media that support techniques for initiating checkpoint operations in a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

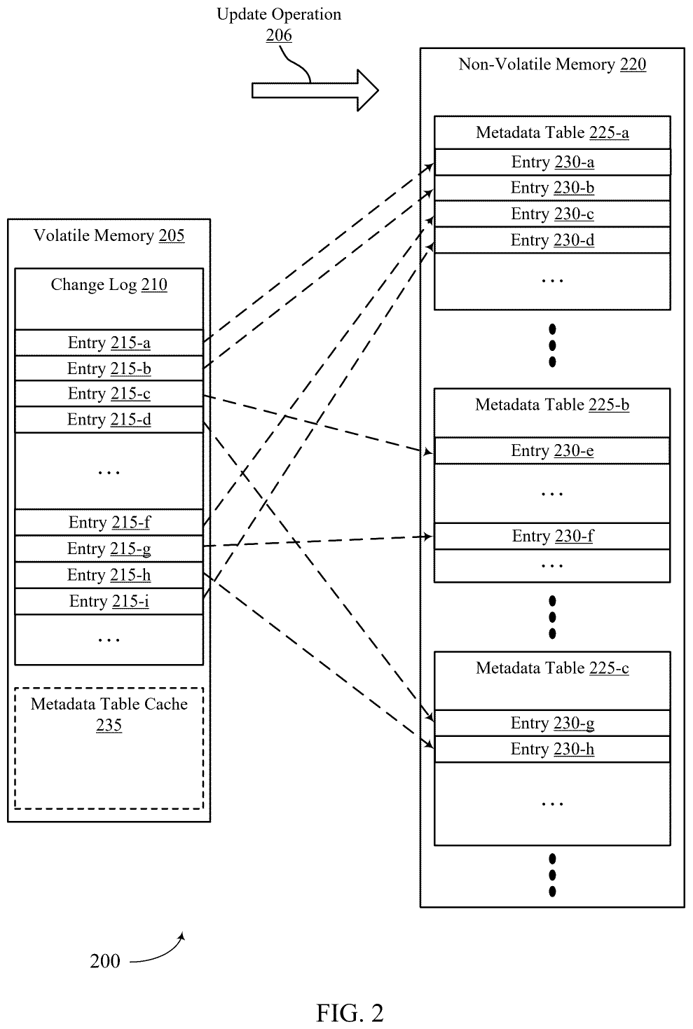

FIG. 2 shows an example of a metadata architecture 200 that supports techniques for initiating checkpoint operations in a memory system in accordance with examples as disclosed herein. The metadata architecture 200 may implement, or be implemented by, aspects of the system 100 (e.g., a memory system 110) as described herein with reference to FIG. 1. For example, the metadata architecture 200 may implement a volatile memory 205 of a memory system 110, which may be included in a local memory 120, and a non-volatile memory 220 of the memory system 110, which may be included in one or more memory devices 130 or other non-volatile storage of the memory system 110 (e.g., non-volatile storage of a memory system controller 115, non-volatile storage of a local memory 120). In some implementations, the non-volatile memory 220 may be distributed across multiple memory devices 130 (e.g., a first portion of the non-volatile memory 220 corresponding to one or more blocks 170 of a first memory device 130 and a second portion of the non-volatile memory 220 corresponding to one or more blocks 170 of a second memory device 130), such as when storing respective metadata associated with data in a given memory device 130.

The techniques described in the context of the metadata architecture 200 may be implemented by a memory system controller 115. For example, according to the techniques described herein, the memory system controller 115 may be configured to perform an update operation 206 (e.g., checkpoint operation) to move entries 215 of a change log 210 stored in the volatile memory 205 to one or more metadata tables 225 of the non-volatile memory 220. The update operation 206 may be performed (e.g., initiated) based on one or more thresholds.

The non-volatile memory 220 may include one or more metadata tables 225, which may store metadata for respective portions of storage of a memory system 110. For example, a metadata table 225 may include L2P tables that map logical addresses (e.g., addresses associated with commands from a host system 105, addresses associated with a logical architecture of a memory system 110) to physical addresses (e.g., memory locations of the memory devices 130), among other metadata. In some examples, each metadata table 225 may be stored in a respective memory location of the one or more memory devices 130, and each may store entries 230 that are associated with a region of memory of a memory system 110, such as an L2P region. A L2P region may refer to a set of addresses of a memory device, such as a range of physical addresses or a set of one or more blocks 170.

In the example of metadata architecture 200, the non-volatile memory 220 may include metadata tables 225-a, 225-b, and 225-c, which may be distributed among one or more memory devices 130. For example, the metadata table 225-a may be stored in a first memory device 130, and include entries 230 (e.g., L2P address mappings or other metadata) that are associated with a first L2P region (e.g., a set of addresses of the first memory device 130). Similarly, the metadata table 225-b may be stored in a different location of the first memory device 130, and include entries 230 that are associated with a second L2P region (e.g., a different set of addresses) of the first memory device 130. In some examples, the metadata table 225-c may be stored in a second memory device 130, and may include entries 230 that are associated with an L2P region of the second memory device 130. Thus, in accordance with these and other examples, each metadata table 225 may be stored in a respective portion of a memory device 130, and may include entries associated with an L2P region (e.g., of the same memory device 130, of a different memory device 130).

In some examples, rather than updating the metadata tables 225 on a command-by-command basis (e.g., in response to each received command from a host system 105), which may incur an increased amount of latency at the memory system, a memory system controller 115 may use the change log 210 (e.g., including at least an address mapping table) to accumulate L2P address mapping updates for multiple commands, among other metadata. For example, a memory system controller 115 may perform an access operation at an address of a memory device 130 and store (e.g., write or update) an L2P address mapping for the access operation as an entry 215 of the change log 210. In some examples, the memory system controller 115 may continue to perform access operations and update the entries 215 (e.g., L2P address mappings) in the change log 210 until the change log 210 reaches capacity.

In some examples, if the change log 210 has reached its capacity, a memory system controller 115 may update the metadata tables 225 with entries 215 from the change log 210. That is, the memory system controller 115 may perform the update operation 206 to write entries 230 with information of the entries 215 in response to a quantity of entries 215 (e.g., L2P address mappings) of the change log 210 reaching a threshold (e.g., a size of the change log 210, a quantity entries 215 that the change log 210 is capable of storing)

In some examples, the change log 210 may include a foreground change log bin (e.g., used during foreground operations) and a background change log bin (e.g., used during background operations). In background operations, a memory system 110 may support ongoing access operations, such as responding to read or write commands issued by a host system 105. For example, a memory system controller 115 may concurrently perform access operations at one or more memory devices 130 and also store, as part of a background operation, an L2P address mapping associated with the access operations in one or more entries 215 of the background change log bin. In a foreground operation, such as the update operation 206, the memory system controller 115 may not support ongoing access operations, and therefore may refrain from performing access operations.

In some examples, in response to identifying that the background change log bin of the change log 210 has reached capacity, a memory system controller 115 may refrain from performing access operations in order to perform the update operation 206. The memory system controller 115 may begin the update operation 206 by inserting the entries 215 of the background change log bin into entries 215 of the foreground change log bin. In response to inserting the entries 215 of the background change log bin into the foreground change log bin, the memory system controller 115 may swap the contents of the foreground change log bin with the background change log bin, thereby clearing the entries 215 of the background change log bin.

To support the update operation 206, the memory system controller 115 may load (e.g., sequentially, in accordance with different L2P regions) metadata tables 225 to be updated into a cache (e.g., of the memory system controller 115, of local memory 120, of the volatile memory 205), such as moving a metadata table 225 from non-volatile memory 220 to a metadata table cache 235 (e.g., in SRAM). The memory system controller 115 may update the information of the metadata tables 225 in the metadata table cache 235 by moving information of the entries 215 of the foreground change log into the respective entries 230 of the metadata tables 225 (e.g., in the metadata table cache 235), and write the updated metadata tables 225 from the metadata table cache 235 back to the non-volatile memory 220. After updating the metadata tables 225 (e.g., to the non-volatile memory 220), the memory system controller 115 may clear the foreground change log bin and resume access operations.

As an illustrative example of an update operation 206, a memory system controller 115 may load the metadata table 225-a from the non-volatile memory 220 to a cache and determine that entries 215-a, 215-b, 215-f, and 215-i of the change log 210 (e.g., the foreground bin) correspond to an L2P region associated with the metadata table 225-a. Accordingly, the memory system controller 115 may update (e.g., in the cache) an entry 230-a with the entry 215-a, update an entry 230-b with the entry 215-b, update an entry 230-c with the entry 215-f, and update an entry 230-d with the entry 215-i. After updating the metadata table 225-a in the cache, the memory system controller 115 may write the metadata table 225-a back to the non-volatile memory 220 and load the metadata table 225-b into the cache. The memory system controller 115 may determine that entries 215-c and 215-g correspond to the L2P region associated with the metadata table 225-b, and may update an entry 230-e and an entry 230-f with the entry 215-c and the entry 215-g, respectively. The memory system controller 115 may write the metadata table 225-b back to the non-volatile memory 220 and load the metadata table 225-c into the cache. The memory system controller 115 may determine that entries 215-d and 215-h correspond to the L2P region associated with the metadata table 225-c, and may update an entry 230-g and an entry 230-h of the metadata table 225-c with the entry 215-d and the entry 215-h, respectively. Thus, in accordance with these and other examples, a memory system controller 115 may move entries 215 from volatile memory 205 to corresponding metadata tables 225 in non-volatile memory 220.

In some examples, if the update operation 206 is a foreground operation, a memory system controller 115 may refrain from servicing requests from a host system 105. However, ignoring such requests may result in extended operating delays of the system, which may negatively impact user experience. For example, a memory system 110 may receive access commands that are associated with latency metrics (e.g., are sensitive to latency). However, a memory system controller 115 may block servicing the access commands during an update operation 206, resulting in the memory system controller 115 being unable to satisfy latency metrics associated with such commands.

In some examples, a duration to perform the update operation 206 may be relatively longer as the quantity of metadata tables 225 increases. As an illustrative example, if the change log 210 has a capacity of 8000 entries 215, then the memory system 110 may incur a latency associated with transferring as many as 8000 metadata tables 225 from non-volatile memory 220 to a cache for updating (e.g., associated with updating as many as 8000 L2P regions), which may result in a relatively long duration of being unavailable to service access requests from a host system 105.

In accordance with the techniques described herein, a memory system controller 115 may, in some cases, be configured to initiate an update operation 206 prior to a change log 210 reaching capacity. For example, a memory system controller 115 may be configured to initiate an update operation 206 based on a quantity of metadata tables 225 (e.g., L2P regions) to be updated satisfying a threshold (e.g., a first threshold, such as 2000 metadata tables 225), which may reduce a duration for performing an update operation 206. By limiting a quantity of metadata tables 225 to be updated during a given update operation 206 (e.g., a max checkpoint overhead), the memory system controller 115 may be able to perform the update operation 206 in a timely manner, thereby limiting the latency for responding to access commands (e.g., from a host system 105).

In an example implementation, a memory system controller 155 may initiate an update operation 206 in response to a quantity of metadata tables 225 (e.g., L2P regions) associated with entries 215 satisfying (e.g., being equal to, being greater than, reaching) a first threshold, or in response to a quantity of entries 215 themselves satisfying (e.g., being equal to, reaching) a second threshold (e.g., reaching a capacity of entries 215, an APL flow control threshold). A memory system controller 115 may account for the quantity of metadata tables 225 using a bitmap array, a first counter, or both. Similarly, a memory system controller 115 may account for a total quantity of entries 215 in the change log 210 using a second counter.

In some examples, a memory system controller 115 may reset a counter (e.g., an incrementing counter, a bitmap counter) that tracks a total quantity of metadata tables 225 for updating in an update operation 206 as part of performing a background update. The memory system controller 115 may update (e.g., increment) such a counter to monitor the quantity of metadata tables 225 for a subsequent update operation 206, such as when a new entry 215 is added to a change log 210 (e.g., inserting a new change log into a foreground change log bin). In some examples, in response to completing the updates to the background change log bin, the memory system controller 115 may initiate the update operation 206 based on the quantity of metadata tables 225 associated with the entries of the foreground change log bin satisfying the first threshold or based on the total quantity of entries of the foreground change log bin satisfying the second threshold (e.g., reaching capacity). In other words, in response to performing an update operation 206, a memory system controller 115 may reset a counter and begin monitoring the quantity of entries 215 of the change log 210 and associated quantity of metadata tables 225. In some cases, in response to the quantity of metadata tables 225 to be updated satisfying the first threshold, the memory system controller 115 may begin the update operation 206, which may include refraining from receiving write commands from a host system 105. Alternatively, if the quantity of metadata tables 225 to be updated does not satisfy the first threshold, the memory system controller 115 may begin the update operation 206 based on the total quantity of entries 215 of the change log 210 satisfying the second threshold.

As an illustrative example, the first threshold may be equal to 2000 (e.g., a threshold of 2000 metadata tables 225 for a given update operation 206) and the second threshold may be equal to 8000 (e.g., a capacity of 8000 entries 215 in the change log 210, a threshold of 8000 entries for a given update operation 206). In such examples, the memory system controller 115 may perform access operation and store, in respective entries 215 of the change log 210, L2P address mappings among other metadata associated with the access operations, where each entry 215 may correspond to a respective metadata table 225 (e.g., L2P region). As such, if the quantity of metadata tables 225 of the entries 215 reaches 2000, then the memory system controller 115 may initiate the update operation 206 to update the 2000 metadata tables 225. As such, the memory system controller may load, on a table-by-table basis, the 2000 metadata tables 225 into the cache, update entries 230 of the metadata tables 225 with the respective entries 215 of the change log 210, and write back the metadata tables 225 to non-volatile memory 220. In this way, the memory system controller 115 may perform the update operation 206 prior to the change log 210 reaching capacity, which may reduce a duration over which the memory system 110 may be unavailable to service commands from a host system, thereby reducing latency and improving user experience.

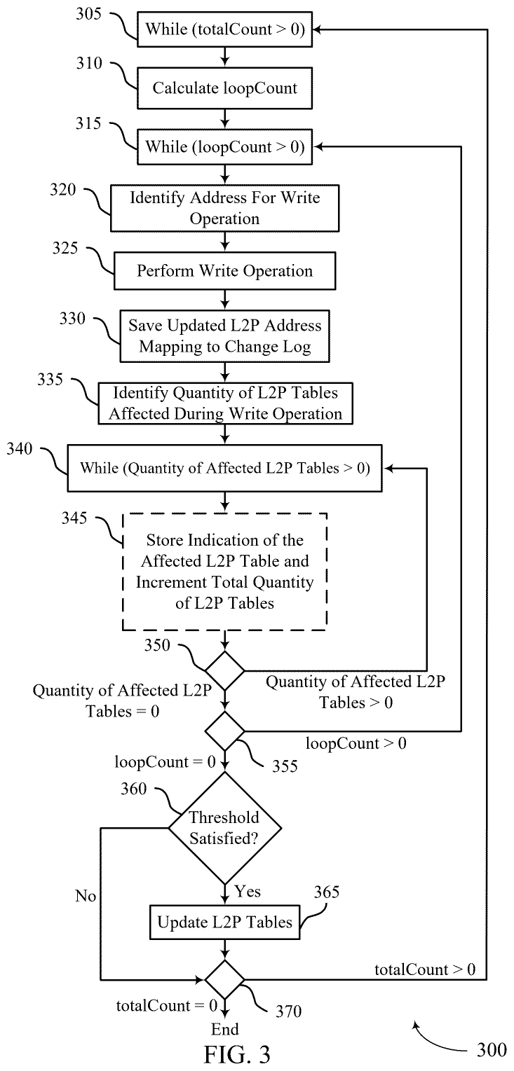

FIG. 3 shows an example of a process 300 that supports techniques for initiating checkpoint operations in a memory system in accordance with examples as disclosed herein. Aspects of the process 300 may implement, or be implemented by, aspects of the system 100 and the metadata architecture 200 as described herein. For example, aspects of the process 300 may be implemented by a controller (e.g., of a memory system 110, a memory system controller 115), among other components. Additionally, or alternatively, aspects of the process 300 may be implemented as instructions stored in memory (e.g., firmware stored in local memory 120 coupled with a memory system controller 115). For example, the instructions, when executed by a controller (e.g., a memory system controller 115), may cause the controller to perform the operations of the process 300. The techniques described in the context of the process 300 may support a memory system 110 to dynamically initiate checkpoint procedures according to one or more thresholds.

At 305, a total quantity of write operations (e.g., totalCount) may be identified. For example, the controller may receive write commands from a host system 105 and determine a quantity of write operations that are to be performed at one or more memory devices (e.g., memory devices 130). In such examples, the controller may perform the operations of process 300 while the memory system 110 has write operations to perform (e.g., while totalCount >0).

At 310, an iteration count (e.g., loopCount) may be calculated. For example, the controller may determine the iteration count, which may represent a quantity of write operations the memory system 110 is able to perform (e.g., a capacity of the memory system to perform the write operations). In such examples, the controller may determine the iteration count to be the minimum value between the total quantity of write operations identified at 305 and a quantity of available entries in a change log (e.g., a quantity of entries 215, as a calculation loopCount=min (totalCount, available entries in foreground change log bin)). At 315, the controller may perform the operations of 320-355 while the iteration count is greater than zero.

At 320, an address for a write operation may be identified. For example, to identify the address, the controller may calculate a size of data, such as quantity of consecutive LBAs or a quantity of physical page addresses (PPAs), and identify where in one or more memory devices 130 the data can be stored. At 325, the write operation may be performed. For example, in response to identifying the address at 320, the controller may indicate, to a local controller of the memory device, the address associated with the write operation, where the local controller of the memory device may initiate the write operation for the identified address (e.g., insert the data to the L2P region).

At 330, an entry of the change log 210 may be updated. For example, in response to, or in conjunction with, initiating the write operation at 325, the controller may update (e.g., save) an L2P address mapping of the write operation in an entry 215 of the change log 210, where the L2P address mapping may be associated with one or more L2P tables (e.g., one or more metadata tables 225, one or more L2P regions) of the memory system 110.

At 335, a quantity of affected L2P tables may be identified. For example, the controller may identify a quantity of L2P tables (e.g., a count of L2P regions) affected by one or more write operations (e.g., since a prior update operation 206). As an illustrative example, at 325, the write operation may be associated with an address of the memory system 110 that is associated with portions of two L2P regions. Accordingly, the controller may identify that two L2P regions were affected during the write operation and that the two L2P tables associated with the two L2P regions are to be updated during the checkpoint procedure (e.g., update operation 206). At 340 (e.g., while the quantity of affected L2P tables is greater than 0), the controller may proceed to perform the operations of 345 for each identified L2P table affected by the write operation.

At 345, an indication of the affected L2P table may be stored (e.g., in an entry 215). The controller may account for a total quantity of L2P tables (e.g., the total quantity of affected L2P regions) associated with the entries of the change log using a bitmap array. In some examples, the bitmap array may have a size of eight kilobytes (8 KB) (e.g., 64,000 bits), where each bit in the bitmap array may correspond to a respective L2P table, and where each respective L2P table may cover a 4 megabyte region (MB) of non-volatile memory (e.g., L2P region). Accordingly, the controller may account for (e.g., keep track of) a data capacity of 256 gigabytes (GB) (e.g., 8000 bytes*8 bits per byte*4 MB L2P Region=256,000 MB of non-volatile memory=256 GB non-volatile memory) using the bitmap array.

In some other examples, the controller may use a bitmap counter with reduced granularity (e.g., as an estimated quantity of L2P regions) in order to account for the updated L2P tables in a larger capacity system (e.g., 1 terabyte (TB) of non-volatile memory in one or more memory devices 130). In such examples, the controller may expand the bitmap array to cover one TB of non-volatile memory by masking the two most significant bits (MSBs) of an identifier of the L2P table (e.g., mask the 2 higher valid bits of the LBA number). Accordingly, each bit of the bitmap array may be associated with four L2P tables that are grouped according to the two MSBs of the L2P table identifiers (e.g., 8000 bytes*8 bits per byte*4 L2P regions*4 MB per L2P region=1,024,000 MB of non-volatile memory=1 TB of non-volatile memory).

To store the indication of the L2P table, the controller may calculate a bitmap index (e.g., a row or a column of the bitmap array) for the L2P table according to one or more parameters associated with the write operation, such as an identifier of the memory device 130 where the write operation occurred, a range of LBAs, a portion (e.g., subset of bits) of an identifier associated with the L2P table, or a combination thereof. For example, the controller may index the bitmap array according to identifiers of memory devices 130 in the memory system 110, such that respective sets of rows of the bitmap array may be associated with a single memory device 130. In response to calculating the bitmap index, the controller may calculate a bit position that corresponds to the updated L2P table. For example, the controller may determine, out of the identified rows or columns of the bitmap array, the bit position that is associated with the updated L2P table (e.g., the affected L2P region).

In response to identifying the bit position associated with the L2P table, the controller may determine whether the bit associated with the updated L2P table has already been inserted (e.g., set) based on the bit value of the bit. For example, the controller may identify a bit value of the bit, where a first bit value (e.g., ‘1’ or ‘0’) may indicate the L2P region has been affected from a previous write operation and a second bit value (e.g., ‘1’ or ‘0’) may indicate that the L2P region has not been affected. Accordingly, if the bit value of the bit indicates that the L2P table has not been affected by a previous write operation, then the controller may set the bit to the first bit value to indicate that the L2P table is affected by the write operation and increment the total quantity of L2P tables (e.g., a first counter). Alternatively, if the bit value of the bit indicates that the L2P table has been affected by a previous write operation, the controller may maintain the bit value of the bit and refrain from incrementing the total quantity of L2P tables.

As an illustrative example, in a first iteration of operations of 320-345, the controller may perform a first write operation at a first address of a first memory device 130, where the first address corresponds to a first L2P table (e.g., a first metadata table 225). The controller may store a first L2P address mapping (e.g., a first entry 215) associated with the first write operation in the change log. In response to storing the first L2P address, the controller may set a bit in the bitmap array to the first bit value in order to indicate that the first L2P region has been affected and increment the total quantity of updated L2P tables. In a second iteration of the operations of 320-345, the controller may perform a second write operation at a second address of the first memory device 130. The controller may store a second L2P address mapping associated with the second write operation in the change log 210. The controller may determine that the second L2P address mapping also corresponds to the first L2P table (e.g., the first and second write operations are at the same L2P region). As such, the controller may refrain from incrementing the total quantity of updated L2P tables.

At 350, the quantity of L2P tables may be decremented. For example, after each iteration of the operations of 345 (one iteration for each identified quantity of L2P tables at 335), the controller may decrement the quantity of L2P tables and determine whether to perform another iteration of the operations of 345 or proceed to operation 355. That is, if the quantity of L2P tables is greater than zero, then the controller may proceed to perform another iteration of the operations of 345. Alternatively, if the quantity of L2P tables is equal to zero (e.g., each of the L2P tables affected by the write operation have been accounted for), then the controller may proceed to perform the operations of 355.

As an illustrative example, if the write operation performed at 325 affected two L2P tables, then the quantity of L2P tables identified at 335 may be equal to two. Accordingly, after a first iteration of the operations of 345 for the first L2P table, the controller may decrement the quantity of L2P tables and perform the operations of 345 for the second L2P table affected by the write operation. In response to performing the operations of 345 for both L2P tables, the controller may decrement the quantity of L2P tables, such that the quantity of L2P tables is equal to zero and proceed to 355.

At 355, the iteration count (e.g., loopCount) may be decremented. For example, after the operations of 320-345 for the write operation have been performed, the controller may decrement the iteration count by one to indicate that a single iteration of operations of 320-345 for a single write command have been completed. Accordingly, if the iteration count is greater than zero after decrementing, the controller may continue to perform operations of 320-345 for a respective write command according to the iteration count (e.g., the quantity of write operations the controller is capable of performing). Alternatively, if the iteration count is equal to zero in response to the decrementing, the controller may proceed to 360.

At 360, a threshold may be checked. For example, in response to the write operations being completed (e.g., loopCount reaching 0), the controller may determine whether to update L2P tables (e.g., checkpoint procedure, update operation 206) based on the total quantity of updated L2P tables of the L2P address mappings in the changelog satisfying a first threshold or the total quantity of entries in the change log satisfying a second threshold (e.g., the change log reaches capacity).

In some examples, the controller may determine that the total quantity of updated L2P tables (e.g., L2P regions) of the L2P address mappings satisfies the first threshold. In such examples, the controller may proceed to update the L2P tables at 365. Similarly, the controller may determine that the total quantity of L2P address mappings (e.g., entries in the changelog) satisfy the second threshold. In such examples, the controller may proceed to update the L2P tables at 365.

At 365, the L2P tables associated with the L2P address mappings may be updated. In some examples, the controller may perform the checkpoint procedure to update the L2P tables in accordance with an update operation 206, which may involve loading one or more metadata tables 225 from non-volatile memory 220 into a metadata table cache 235, updating the metadata tables 225 with information from entries 215 of the change log 210, and loading the updated metadata tables 225 back to non-volatile memory 220. In response to completing the checkpoint procedure (e.g., update operation 206), the controller may empty the change log 210 (e.g., erase or clear the entries 215 of the change log 210), reset the bits of the bitmap array, and reset the total quantity of updated L2P tables (e.g., first counter) to zero.

At 370, the total quantity of write operations (e.g., totalCount) may be decremented. For example, the controller may decrement the total quantity of write operations by the iteration count (e.g., the quantity of write operations performed during operations of 320-345). Accordingly, If the total quantity of write operations have been completed (e.g., totalCount=0), the controller may end the process 300 and begin monitoring for additional write commands. Alternatively, the controller may proceed to perform the operations of the process 300 for one or more write commands received at 305.

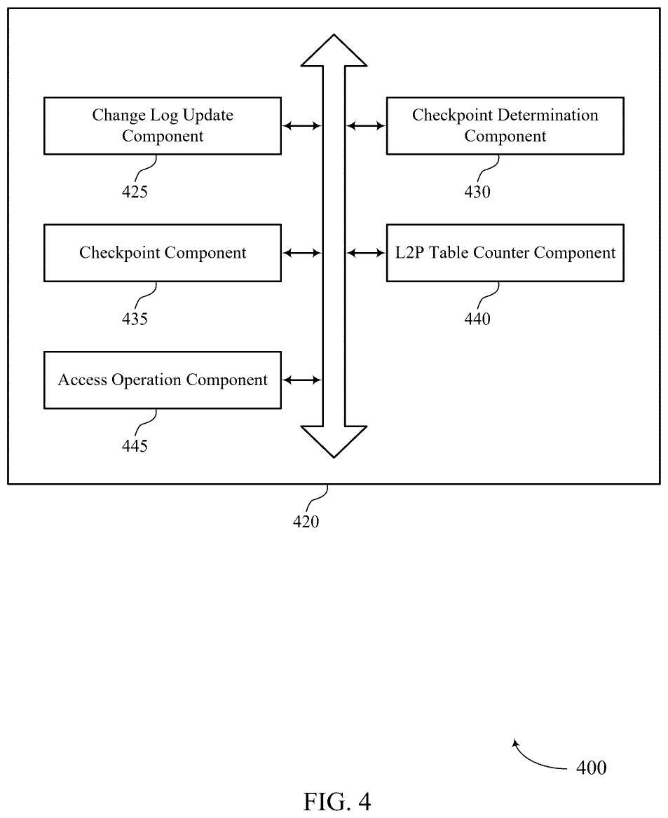

FIG. 4 shows a block diagram 400 of a memory system 420 that supports techniques for initiating checkpoint operations in a memory system in accordance with examples as disclosed herein. The memory system 420 may be an example of aspects of a memory system 110 as described with reference to FIGS. 1 through 3. The memory system 420, or various components thereof, may be an example of means for performing various aspects of techniques for initiating checkpoint operations in a memory system as described herein. For example, the memory system 420 may include a change log update component 425, a checkpoint determination component 430, a checkpoint component 435, a L2P table counter component 440, an access operation component 445, or any combination thereof. Each of these components, or components of subcomponents thereof (e.g., one or more processors, one or more memories), may communicate, directly or indirectly, with one another (e.g., via one or more buses).

The change log update component 425 may be configured as or otherwise support a means for updating, in volatile memory of the memory system (e.g., volatile memory 205), a plurality of L2P address mappings (e.g., entries 215, of a change log 210), each of the plurality of L2P address mappings corresponding to a respective L2P table (e.g., a respective metadata table 225) in non-volatile memory of the memory system (e.g., non-volatile memory 220). The checkpoint determination component 430 may be configured as or otherwise support a means for determining whether to update the respective L2P tables in the non-volatile memory based at least in part on a quantity of the respective L2P tables of the updated plurality of L2P address mappings (e.g., a quantity of metadata tables 225 associated with the entries 215 of a change log 210) satisfying a first threshold or a quantity of updated L2P address mappings of the plurality of updated L2P address mappings (e.g., a quantity of entries 215 of the change log 210) satisfying a second threshold. The checkpoint component 435 may be configured as or otherwise support a means for updating the respective L2P tables in the non-volatile memory with the updated plurality of L2P address mappings in the volatile memory (e.g., performing an update operation 206) based at least in part on the determination. In some examples, updating the respective L2P tables may be associated with a checkpoint operation.

In some examples, to support determining whether to update the respective L2P tables, the checkpoint determination component 430 may be configured as or otherwise support a means for determining to update the respective L2P tables in the non-volatile memory based at least in part on the quantity of respective L2P tables of the updated L2P address mappings satisfying the first threshold.

In some examples, to support determining to update the respective L2P tables, the checkpoint determination component 430 may be configured as or otherwise support a means for determining to update the respective L2P tables in the non-volatile memory before the quantity of updated L2P address mappings of the plurality of updated L2P address mappings satisfies the second threshold.

In some examples, the L2P table counter component 440 may be configured as or otherwise support a means for storing an indication of the quantity of respective L2P tables (e.g., in an incrementing counter, in a bitmap counter), where determining whether to update the respective L2P tables is based at least in part on the stored indication.

In some examples, to support storing the indication, the L2P table counter component 440 may be configured as or otherwise support a means for setting, in response to updating one of the plurality of L2P address mappings, a bit indicating that at least one of a set of multiple L2P tables has been updated (e.g., in a bitmap counter), where the quantity of the respective L2P tables is determined based at least in part on setting the bit.

In some examples, the access operation component 445 may be configured as or otherwise support a means for refraining from performing one or more access operations in response to updating the respective L2P tables.

In some examples, each L2P table may correspond to a respective region of memory cells of one or more memory devices of the memory system (e.g., one or more L2P regions, or one or more memory devices 130).

In some examples, updating the plurality of L2P address mappings may be based at least in part on one or more write operations responsive to one or more write commands received at the memory system (e.g., from a host system 105).

In some examples, the non-volatile memory includes NAND memory of one or more memory devices of the memory system (e.g., of one or more memory devices 130), and the volatile memory includes static random access memory associated with a controller coupled with the one or more memory devices (e.g., of a local memory 120, of or coupled with a memory system controller 115).

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

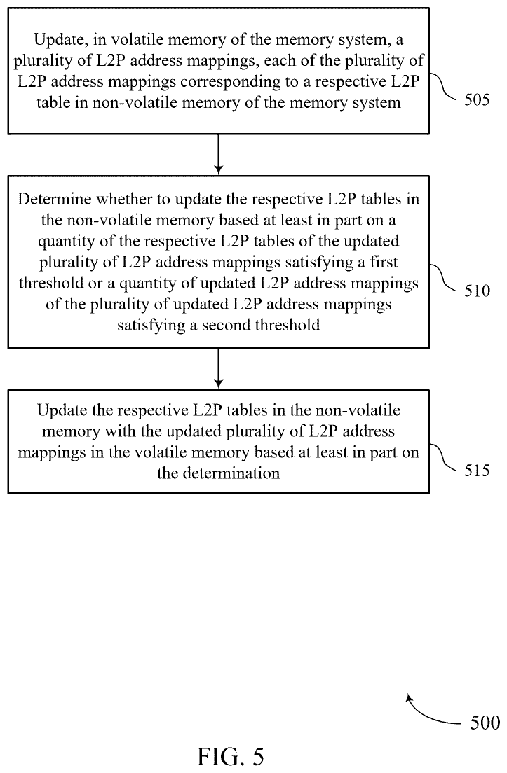

FIG. 5 shows a flowchart illustrating a method 500 that supports techniques for initiating checkpoint operations in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include updating, in volatile memory of the memory system, a plurality of L2P address mappings, each of the plurality of L2P address mappings corresponding to a respective L2P table in non-volatile memory of the memory system. In some examples, aspects of the operations of 505 may be performed by a change log update component 425 as described with reference to FIG. 4.

At 510, the method may include determining whether to update the respective L2P tables in the non-volatile memory based at least in part on a quantity of the respective L2P tables of the updated plurality of L2P address mappings satisfying a first threshold or a quantity of updated L2P address mappings of the plurality of updated L2P address mappings satisfying a second threshold. In some examples, aspects of the operations of 510 may be performed by a checkpoint determination component 430 as described with reference to FIG. 4.

At 515, the method may include updating the respective L2P tables in the non-volatile memory with the updated plurality of L2P address mappings in the volatile memory based at least in part on the determination. In some examples, aspects of the operations of 515 may be performed by a checkpoint component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry (e.g., processing circuitry), logic, means, or instructions, or any combination thereof for updating, in volatile memory of the memory system, a plurality of L2P address mappings, each of the plurality of L2P address mappings corresponding to a respective L2P table in non-volatile memory of the memory system; determining whether to update the respective L2P tables in the non-volatile memory based at least in part on a quantity of the respective L2P tables of the updated plurality of L2P address mappings satisfying a first threshold or a quantity of updated L2P address mappings of the plurality of updated L2P address mappings satisfying a second threshold; and updating the respective L2P tables in the non-volatile memory with the updated plurality of L2P address mappings in the volatile memory based at least in part on the determination.
Aspect 2: The method, apparatus, or non-transitory computer-readable medium of aspect 1, where determining whether to update the respective L2P tables includes operations, features, circuitry, logic, means, or instructions, or any combination thereof for determining to update the respective L2P tables in the non-volatile memory based at least in part on the quantity of respective L2P tables of the updated L2P address mappings satisfying the first threshold.
Aspect 3: The method, apparatus, or non-transitory computer-readable medium of aspect 2, where determining to update the respective L2P tables includes operations, features, circuitry, logic, means, or instructions, or any combination thereof for determining to update the respective L2P tables in the non-volatile memory before the quantity of updated L2P address mappings of the plurality of updated L2P address mappings satisfies the second threshold.
Aspect 4: The method, apparatus, or non-transitory computer-readable medium of any of aspects 1 through 3, further including operations, features, circuitry, logic, means, or instructions, or any combination thereof for storing an indication of the quantity of respective L2P tables, where determining whether to update the respective L2P tables is based at least in part on the stored indication.
Aspect 5: The method, apparatus, or non-transitory computer-readable medium of aspect 4, where storing the indication includes operations, features, circuitry, logic, means, or instructions, or any combination thereof for setting, in response to updating one of the plurality of L2P address mappings, a bit indicating that at least one of a set of multiple L2P tables has been updated, where the quantity of the respective L2P tables is determined based at least in part on setting the bit.
Aspect 6: The method, apparatus, or non-transitory computer-readable medium of any of aspects 1 through 5, further including operations, features, circuitry, logic, means, or instructions, or any combination thereof for refraining from performing one or more access operations in response to updating the respective L2P tables.
Aspect 7: The method, apparatus, or non-transitory computer-readable medium of any of aspects 1 through 6, where updating the respective L2P tables is associated with a checkpoint operation.
Aspect 8: The method, apparatus, or non-transitory computer-readable medium of any of aspects 1 through 7, where each L2P table corresponds to a respective region of memory cells of one or more memory devices of the memory system.
Aspect 9: The method, apparatus, or non-transitory computer-readable medium of any of aspects 1 through 8, where updating the plurality of L2P address mappings is based at least in part on one or more write operations responsive to one or more write commands received at the memory system.
Aspect 10: The method, apparatus, or non-transitory computer-readable medium of any of aspects 1 through 9, where the non-volatile memory includes NAND memory of one or more memory devices of the memory system, and the volatile memory includes static random access memory associated with a controller coupled with the one or more memory devices.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and second condition or action may occur directly as a result of the previous condition or action occurring independent of whether other conditions or actions occur. In some examples, a first condition or action may be performed, and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
update, in volatile memory of the memory system, a plurality of logical-to-physical (L2P) address mappings, each of the plurality of L2P address mappings corresponding to a respective L2P table in non-volatile memory of the memory system;
determine whether to update the respective L2P tables in the non-volatile memory based at least in part on a quantity of the respective L2P tables of the updated plurality of L2P address mappings satisfying a first threshold or a quantity of updated L2P address mappings of the plurality of updated L2P address mappings satisfying a second threshold; and
update the respective L2P tables in the non-volatile memory with the updated plurality of L2P address mappings in the volatile memory based at least in part on the determination.

2. The memory system of claim 1, wherein, to determine whether to update the respective L2P tables, the processing circuitry is configured to cause the memory system to:
determine to update the respective L2P tables in the non-volatile memory based at least in part on the quantity of respective L2P tables of the updated L2P address mappings satisfying the first threshold.

3. The memory system of claim 2, wherein, to determine to update the respective L2P tables, the processing circuitry is configured to cause the memory system to:
determine to update the respective L2P tables in the non-volatile memory before the quantity of updated L2P address mappings of the plurality of updated L2P address mappings satisfies the second threshold.

4. The memory system of claim 1, wherein the processing circuitry is further configured to cause the memory system to:
store an indication of the quantity of respective L2P tables; and
determine whether to update the respective L2P tables based at least in part on the stored indication.

5. The memory system of claim 4, wherein, to store the indication, the processing circuitry is configured to cause the memory system to:
set, in response to updating one of the plurality of L2P address mappings, a bit indicating that at least one of a set of multiple L2P tables has been updated, wherein the quantity of the respective L2P tables is determined based at least in part on setting the bit.

6. The memory system of claim 1, wherein the processing circuitry is further configured to cause the memory system to:
refrain from performing one or more access operations in response to updating the respective L2P tables.

7. The memory system of claim 1, wherein updating the respective L2P tables is associated with a checkpoint operation.

8. The memory system of claim 1, wherein each L2P table corresponds to a respective region of memory cells of the one or more memory devices.

9. The memory system of claim 1, wherein the processing circuitry is configured to cause the memory system to:
update the plurality of L2P address mappings based at least in part on one or more write operations responsive to one or more write commands received at the memory system.

10. The memory system of claim 1, wherein the non-volatile memory comprises NAND memory of the one or more memory devices, and the volatile memory comprises static random access memory associated with the processing circuitry.

11. A non-transitory computer-readable medium storing code comprising instructions which, when executed by one or more processors of a memory system, cause the memory system to:
update, in volatile memory of the memory system, a plurality of logical-to-physical (L2P) address mappings, each of the plurality of L2P address mappings corresponding to a respective L2P table in non-volatile memory of the memory system;
determine whether to update the respective L2P tables in the non-volatile memory based at least in part on a quantity of the respective L2P tables of the updated plurality of L2P address mappings satisfying a first threshold or a quantity of updated L2P address mappings of the plurality of updated L2P address mappings satisfying a second threshold; and
update the respective L2P tables in the non-volatile memory with the updated plurality of L2P address mappings in the volatile memory based at least in part on the determination.

12. The non-transitory computer-readable medium of claim 11, wherein the instructions to determine whether to update the respective L2P tables, when executed by the one or more processors of the memory system, cause the memory system to:
determine to update the respective L2P tables in the non-volatile memory based at least in part on the quantity of respective L2P tables of the updated L2P address mappings satisfying the first threshold.

13. The non-transitory computer-readable medium of claim 12, wherein the instructions to determine whether to update the respective L2P tables, when executed by the one or more processors of the memory system, cause the memory system to:
determine to update the respective L2P tables in the non-volatile memory before the quantity of updated L2P address mappings of the plurality of updated L2P address mappings satisfies the second threshold.

14. The non-transitory computer-readable medium of claim 11, wherein the instructions, when executed by the one or more processors of the memory system, further cause the memory system to:
store an indication of the quantity of respective L2P tables, wherein determining whether to update the respective L2P tables is based at least in part on the stored indication.

15. The non-transitory computer-readable medium of claim 14, wherein the instructions to store the indication, when executed by the one or more processors of the memory system, cause the memory system to:
set, in response to updating one of the plurality of L2P address mappings, a bit indicating that at least one of a set of multiple L2P tables has been updated, wherein the quantity of the respective L2P tables is determined based at least in part on setting the bit.

16. The non-transitory computer-readable medium of claim 11, wherein the instructions, when executed by the one or more processors of the memory system, further cause the memory system to:
refrain from performing one or more access operations in response to updating the respective L2P tables.

17. The non-transitory computer-readable medium of claim 11, wherein updating the respective L2P tables is associated with a checkpoint operation.

18. The non-transitory computer-readable medium of claim 11, wherein each L2P table corresponds to a respective region of memory cells of one or more memory devices of the memory system.

19. The non-transitory computer-readable medium of claim 11, wherein updating the plurality of L2P address mappings is based at least in part on one or more write operations responsive to one or more write commands received at the memory system.

20. The non-transitory computer-readable medium of claim 11, wherein the non-volatile memory comprises NAND memory of one or more memory devices of the memory system, and the volatile memory comprises static random access memory associated with the one or more processors.

21. A method at a memory system, comprising:
updating, in volatile memory of the memory system, a plurality of logical-to-physical (L2P) address mappings, each of the plurality of L2P address mappings corresponding to a respective L2P table in non-volatile memory of the memory system;
determining whether to update the respective L2P tables in the non-volatile memory based at least in part on a quantity of the respective L2P tables of the updated plurality of L2P address mappings satisfying a first threshold or a quantity of updated L2P address mappings of the plurality of updated L2P address mappings satisfying a second threshold; and
updating the respective L2P tables in the non-volatile memory with the updated plurality of L2P address mappings in the volatile memory based at least in part on the determination.

22. The method of claim 21, wherein determining whether to update the respective L2P tables comprises:
determining to update the respective L2P tables in the non-volatile memory based at least in part on the quantity of respective L2P tables of the updated L2P address mappings satisfying the first threshold.

23. The method of claim 22, wherein determining to update the respective L2P tables comprises:
determining to update the respective L2P tables in the non-volatile memory before the quantity of updated L2P address mappings of the plurality of updated L2P address mappings satisfies the second threshold.

24. The method of claim 21, further comprising:
storing an indication of the quantity of respective L2P tables, wherein determining whether to update the respective L2P tables is based at least in part on the stored indication.

25. The method of claim 21, wherein each L2P table corresponds to a respective region of memory cells of one or more memory devices of the memory system.
